(19) United States
(12) Patent Application Publication
(10) Pub. No.: US 2009/0231464 A1
(43) Pub. Date: Sep. 17, 2009

(54) DIGITAL CAMERA, ELECTRONIC DEVICE EQUIPPED WITH DIGITAL CAMERA, IMAGING METHOD FOR DIGITAL CAMERA AND STORAGE MEDIUM PROVIDED WITH PROGRAM OF DIGITAL CAMERA

(75) Inventor: Hifumi Nakamura, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/094,348

(22) PCT Filed: Nov. 21, 2005
(86) PCT No.: PCT/JP2005/021338

§ 371 Date: May 20, 2008

(51) Int. Cl. H04N 5/235

(52) U.S. Cl. 348/229.1; 348/E05.034

(57) ABSTRACT

Provided is a digital camera which can display an image quickly following a change in a position of an object with a small-sized, inexpensive construction at the time of picking up the image of the object in a low brightness. The digital camera is provided with an image pickup unit (110) for picking up an image of an object, a storage unit (130) for storing the image constructed by a signal outputted from the image pickup unit (110) and a control unit (150), which, in a case where the illuminance is less than a predetermined value when the image pickup unit (110) picks up the image of the object during the preview at a display unit (120) and also it is detected that any one of an entirety of the image, a specific object in the image or a digital camera body moves, sets each of a gain value and a frame rate to a value larger than a designed value for photography.

### TECHNICAL FIELD

The present invention relates to a digital camera, an electronic device equipped with a digital camera, an imaging method for a digital camera and a storage medium for storing a program of a digital camera, which pick up an image of an object to store the image data in a storage medium.

### BACKGROUND ART

In recent years, usability of a digital camera has remarkably improved with downsizing or multi-functionality. On the contrary, an image sensor of the digital camera is highly pixilated and further, the image sensor is downsized so as to be suitable for its carry. In consequence, since sensibility of the image sensor is degraded, particularly at the photography in a low brightness, the photography in a longer exposure time by reducing a frame rate is required. However, when an object is photographed in a long exposure time, the frame rate results in a reduction during the preview of in advance displaying the object for photography. Therefore, it raises the problem that it takes time to point a camera at the object for confirming a picture composition of the object.

There is a demand for more downsizing, particularly to a digital camera equipped in a cell phone device and therefore, it is difficult to mount a sufficiently bright optical source such as a flash lamp to such a digital camera. Therefore, a reduction of the frame rate at the photography in a low brightness becomes more remarkable.

In view of the above, for preventing the reduction in the frame rate at the photography in a low brightness, some of conventional digital cameras adopt a method of increasing a gain value of a signal outputted from an image sensor to secure a sufficient signal level. This method, however, also increases the noise level in the same way as the gain value, leading to a deterioration in an image quality of an image which is photographed and stored. Therefore, the conventional digital camera does not increase the gain value over a required value, thus controlling the noise level not to be excessively large and under this condition, reducing the frame rate to maintain a high image quality by the photography in a long exposure time. Such a method of the conventional digital camera is generally used.

In addition, there is proposed a conventional digital camera which has the following method. In a case the illuminance is low at the time of picking up am image of an object, when a position of the object changes during the preview at the time of picking up the image thereof with a digital camera, an exclusive button in advance prepared is pressed to quickly acquire an image of the object in a new position, thus destroying the previous image once before the position of the object changes to start to acquire the image of the object in the new position (for example, refer to Patent Document 1).

Further, there is proposed another conventional digital camera which has the following method. That is, this digital camera is provided with a normal mode of outputting an image signal of an electrical load in accordance with an exposure quantity for each pixel at a live view display and a pixel additional mode of adding a predetermined number of electrical loads of a pixel adjacent in the horizontal direction to output the image signal. In a case the brightness of an object of which an image is picked up is less than a predetermined value, the image signal outputted from the pixel additional mode is processed, which is displayed on a display (for example, refer to Patent Document 2).

### Patent Document 1: Japanese Patent Unexamined Publication No. 2004-312515

### Patent Document 2: Japanese Patent Unexamined Publication No. 2001-285684

### DISCLOSURE OF THE INVENTION

### Problem to be solved by the Invention

However, since in the conventional digital camera, it is required for a photographer to press a button for destroying the image each time the position of the object changes during the preview, the photographer is forced to determine timing of pressing the button and further, results in performing the button operation frequently. In addition, since it is required to arrange an exclusive circuit for performing the pixel addition improving sensibility of the image sensor, it becomes difficult to introduce a general image sensor, which is resultantly the cause of complication, large-sizing or cost-up of the circuit.

The present invention is made in view of the conventional problems and an object of the present invention is to provided a digital camera, an electronic device equipped with a digital camera, an imaging method for a digital camera and a storage medium for storing a program of a digital camera, which can quickly respond to and follow a change in a position of an object with a small-sized, inexpensive construction at the time of picking up an image of the object in a low brightness.

### Means for solving the Problem

A digital camera of the present invention comprises an image pickup unit for picking up an image of an object, a storage unit for storing an image constructed by a signal outputted from the image pickup unit, a control unit including a function for changing a gain value of the signal outputted from the image pickup unit, a function for changing a frame rate at the time of moving a camera, a function for recognizing the gain value and the frame rate and a function for determining whether or not the illuminance of the object is less than a predetermined value and at least one or more of (1) a control unit for determining whether or not an entirety of the image outputted from the image pickup unit stops moving, (2) a control unit for determining whether or not a specific object in the image outputted from the image pickup unit stops moving or (3) a control unit for determining whether or not a digital camera body of the present invention stops moving.

With this construction, in a case where the illuminance of the object is less than the predetermined value during the preview, any one or more movements of the entirety of the image, the specific object in the image or the digital camera body are selected and detected. When it is determined that any one or more of the selected ones do not stop, the digital camera determines that a photographer does not decide a picture composition of the object yet. The gain value is made larger than a designed value for photography based upon this determination, making it possible to control a reduction of the frame rate to be smaller than at the photography. In consequence, at the time of confirming the object in a low brightness during the preview, the object can be confirmed without over-reduction of the frame rate to quickly respond to and follow the change in the position of the object.

When the digital camera of the present invention determines that the illuminance of the object is less than the predetermined value and also that any one or more of the entirety of the image, the specific object in the image or the digital camera body are selected and any one or more of the selected ones stop, it is determined that a photographer has decided a picture composition of the object. After that, the control unit sets each of the gain value and the frame rate to a designed value for photography, thus providing a function for photographing the object with an image quality for photography.

With this construction, since each of the gain value and the frame rate is set to the designed value for photography at the photography, the photography can be carried out with a high image quality by a relatively small number of noises.

In addition, at the time of setting each of the gain value and the frame rate to the designed value for photography, even before the digital camera determines that the photographer has decided the picture composition for photography, when the photographer performs an operation for setting each of the gain value and the frame rate to the designed value for photography, such as an operation of pressing down a photography button, the digital camera may be provided with a method of being capable of photographing the object with the image quality for photography by instantaneously setting each of the gain value and the frame rate to the designed value for photography image. In consequence, the photographer can photograph the object with the image quality for photography at any timing.

Here, the digital camera of the present invention has the function for determining whether or not the illuminance of an object is less than a predetermined value, and the determination as to whether or not the illuminance is less than the predetermined value is made based upon the determination as to a brightness value of an image of an output signal from the image pickup unit. Since the illuminance of the object becomes dark and the brightness value is smaller than the brightness value of an image at the time the illuminance is sufficiently bright, when a frame rate is forcibly to be lowered for sufficiently maintaining the brightness value of the image, it is determined that the illuminance of the object is less than the predetermined value.

In addition, the control unit of the digital camera in the present invention determines whether or not an entirety of an image outputted from the image pickup unit stops moving or whether or not a specific object in the image stops moving by comparing the entirety of the image incorporated with the entirety of the image previously incorporated or comparing a position of the specific object in the image incorporated with a position of the specific object in the image previously incorporated.

With this construction, since the control unit compares the entirety of the image incorporated with the entirety of the image previously incorporated or the position of the specific object in the image incorporated with the position of the specific object in the image previously incorporated, the determination as to whether or not the entirety of the image or the position of the specific object in the image stops moving can be made with an inexpensive construction.

In addition, the determination as to whether or not the specific object in the image outputted from the image pickup unit may be made by detecting a position of the object itself with a sensor such as an infrared sensor to determine the movement of the object.

Further, a determination as to whether or not the digital camera body of the present invention stops moving is made by a direction monitoring unit for monitoring whether or not the digital camera body of the present invention stops moving. The direction monitoring unit includes any one or more of a gyro sensor, a GPS sensor, an angular velocity sensor, a direction sensor and the like. The direction monitoring unit determines whether or not the digital camera body moves by any one or more of these sensors to determine that a photographer has decided a picture composition for photography when the digital camera body does not move.

When an infrared sensor, a gyro sensor, a GPS sensor, an angular velocity sensor, a direction sensor or the like mounted in the conventional digital camera or the conventional electronic device is used as the direction monitoring unit, a group of these sensors can monitor the movement of the digital camera body without mounting a new device. Accordingly, a mounting capacity or a mounting area of the digital camera body is not increased or the cost of the digital camera does not increase and therefore, the digital camera can be provided in a small-sized, inexpensive construction.

### Advantage of the Invention

As described above, the present invention increases a gain value of a signal outputted from the image pickup unit during the preview at the time of picking up an image of an object in a low brightness, thereby leading to an increase in noises, but since the present invention can restrict an excessive reduction of the frame rate, it can quickly respond to and follow a change of a position of the object in an image. In addition, the gain value is lowered to prevent an increase in noises at the photography to reduce the frame rate as in the case of the conventional digital camera, thus photographing the object in a long exposure time. Therefore, an image in a high image quantity can be acquired.

### BRIEF DESCRIPTION OF THE DRAWINGS

FIG. 1 is a block diagram showing a schematic construction of a digital camera in an embodiment of the present invention.

FIG. 2 is a block diagram showing a schematic construction of a digital camera in another embodiment of the present invention.

FIG. 3 is a flow chart showing one example of a program of the digital camera in the embodiment of the present invention.

FIG. 4 is a diagram showing one example of a frame rate and a gain value set in the digital camera in the embodiment of the present invention.

### EXPLANATION OF THE REFERENCE NUMERALS

100: Digital camera

110: Image pickup unit

120: Display unit

130: Storage unit

140: Operation unit

150: Control unit

160: Direction monitoring unit

### PREFERRED EMBODIMENT OF THE INVENTION

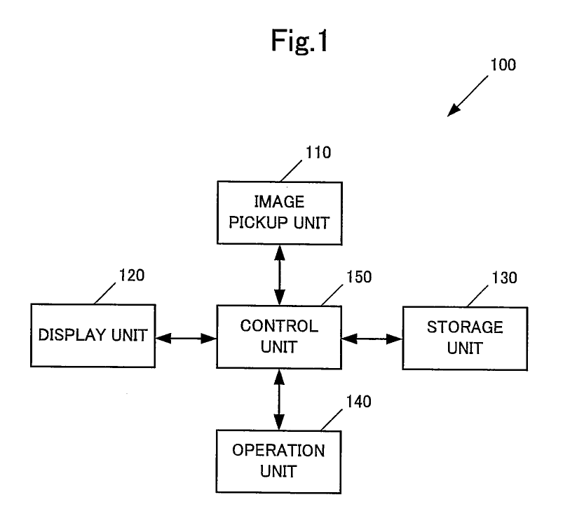

Preferred embodiments of the present invention will hereinafter be explained with reference to the drawings. FIG. 1 is a block diagram showing a schematic construction of a digital camera in an embodiment of the present invention. It should be noted that the digital camera in the present embodiment is not limited to a general digital camera used exclusively for photography, but may be mounted in an electronic device such as a cell phone device.

As shown in FIG. 1, a digital camera 100 is constructed of an image pickup unit 110, a display unit 120, a storage unit 130, an operation unit 140, a control unit 150 and the like.

The image pickup unit 110 comprises an optical system formed with a lens, an aperture and the like, and an imaging device such as a CCD (Charged-Coupled Device) sensor, a CMOS (Complementary Metal-Oxide Semiconductor) sensor, a ν MAICOVICON sensor, or the like. The image pickup unit 110 is adapted to output image data representing an image of an object taken by the imaging device to the control unit 150. It should be noted that the image pickup unit 110 is adapted to take and output an image to the control unit 150 in regular intervals.

The display unit 120 is constructed of a LCD (Liquid Crystal Display) for monitoring, and the like, and is adapted to display the image data or the like outputted from the image pickup unit 110, as an image.

The storage unit 130 is adapted to store the image data or the like outputted from the image pickup unit 110. In addition, a program performed by the control unit 150 and data used in the program are stored in the storage unit 130. The program stored in the storage unit 130 includes, for example, a program of comparing, by using a well-known image recognition technology, the entirety of a current image taken by the image pickup unit 110 or a position of a specific object detected from the current image with the entirety of a previous image taken by the image pickup unit 110 or a position of the specific object detected from the previous image, and detecting a change of the image or a position of the specific object.

The operation unit 140 is constructed of buttons such as for example an operation button for activating the digital camera 100, and a photography button for controlling the photograph and an operation for setting a gain value and a frame rate to designed values for photography such as an operation of pressing down the photograph button, that is, an operation for setting the gain value and the frame rate to an image quality for the photograph. The photography button is a key for commanding a photograph start of an object of which am image is picked up by the imaging device in the image pickup unit 110, to the control unit 150. When the photography button constituting the operation unit 140 is pressed, an image data outputted from the image pickup unit 110 is stored in the storage unit 130.

The control unit 150 is constructed of a processor such as a CPU and performs the program stored in the storage unit 130 to control each unit of the digital camera 100.

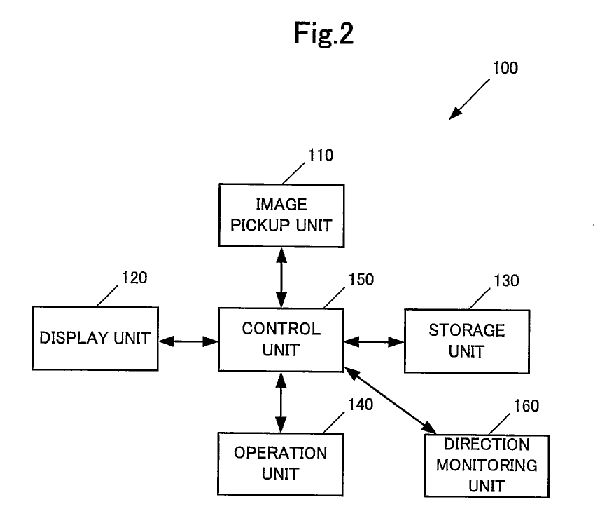

It should be noted that FIG. 2 is a block diagram showing a schematic construction of a digital camera in another embodiment of the present invention. As shown in FIG. 2, the digital camera 100 may comprise a direction monitoring unit 160 such as a gyro sensor, a GPS sensor, an angular velocity sensor or a direction sensor to monitor a change in a direction of the body of the digital camera 100 toward an object.

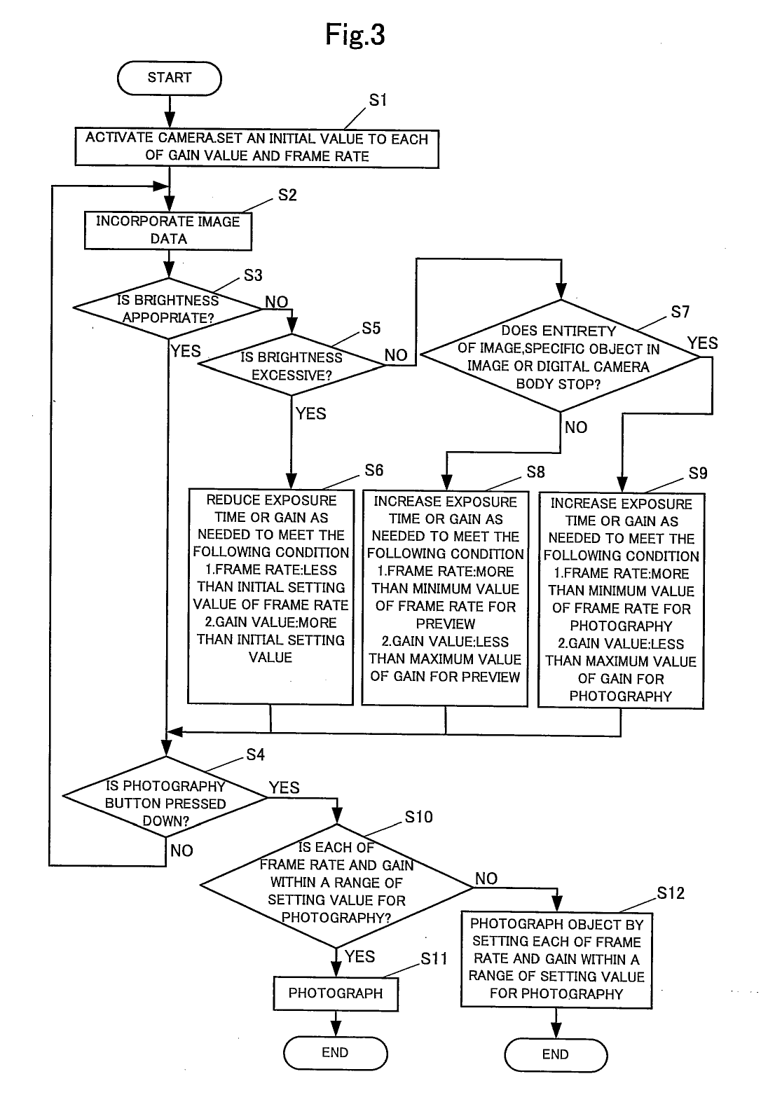

The following description is directed to the program to be performed by the digital camera in the embodiment of the present invention. FIG. 3 is a flow chart showing one example of the program of the digital camera in the embodiment of the present invention. It should be noted that only an operation of being capable of quickly following a change in position of an object during the preview as a function specific in the digital camera 100 and a transfer operation from the preview to the photography will be explained.

In FIG. 3, by performing a key operation of the operation unit 140, the digital camera 100 is activated to assume a preview mode, and to start and an initial value is set to each of a gain value and a frame rate of a signal to be outputted from the image pickup unit 110 at preview starting (step S1).

In addition, image data are taken through the image pickup unit 110 (step S2). The control unit 150 determines whether or not the brightness of the image incorporated is appropriate (step S3). A value of the brightness used in step S3 may be an average value among luminance values of pixels constituting the incorporated image, a luminance value of a part of the incorporated image or a luminance value calculated by weighting a location where the brightness is desired to be heavily measured in the image.

When the control unit 150 determines that the brightness of the image is not appropriate, that is, or when the control unit 150 determines that the calculated luminance value is not within a predetermined range, the control unit 150 determines whether or not the image is excessively bright by determining whether or not the calculated luminance value is larger than a predetermined range (step S5).

Next, when the control unit 150 determines that the calculated luminance value is larger than the predetermined range, the exposure time or gain value is reduced as needed (step S6). In this case, a reduction quantity of the exposure time or a reduction quantity of the gain value is used according to the standard for prescribing performance or the like of the digital camera 100. In addition, the control unit 150 may reduce the exposure time and the gain value simultaneously. It should be noted that the control unit 150 sets the exposure time or gain value at a reduction thereof so that the frame rate does not exceed an initial setting value or the gain value is not less than an initial setting value.

When the control unit 150 determines in step S5 that the calculated luminance value is smaller than the predetermined range, the control unit 150 determines whether or not an entirety of an image, a specific object in the image or the body of the digital camera 100 stops moving (step S7). In addition, the control unit 150 determines whether or not the entirety of the image or the specific object in the image stops moving, by comparing the entirety of the image incorporated with the entirety of the image previously incorporated or the position of the specific object in the image incorporated with the position of the specific object in the image previously incorporated, by using the well-known image recognition technology. In addition, the digital camera 100 may be provided with an infrared sensor which directly determines whether or not the specific object in the image stops moving.

In addition, in step S7, as explained in FIG. 2, the direction monitoring unit 160 is directed to the digital camera 100 and the control unit 150 determines whether or not the body of the digital camera 100 stops moving by using the direction monitoring unit 160, thereby also making it possible to determine whether or not a photographer has decided a picture composition of an object. Further, there is also a method where both of the aforementioned image recognition technology and the direction monitoring unit 160 are used and the confirmation results by the both are used as the determination standard as to whether or not the photographer has decided the picture composition of the object. In addition, in a method of using the direction monitoring unit 160 explained in FIG. 2, there is also a method of determining whether or not the photographer has decided the picture composition of the object, based only upon whether or not the body of the digital camera 100 stops moving without use of the image recognition technology.

It should be noted that it is sufficient if this stopping state of the body of the digital camera 100 is used for determining whether or not the photographer has decided the picture composition of the object. Therefore, whether or not the photographer has decided the picture composition of the object may be also determined based upon the stopping time or information acquired from the image (for example, outline information or the like).

Next, when the control unit 150 determines that the entirety of the image, the specific object in the image or the body of the digital camera 100 does not stops moving, the exposure time or gain value is made to increase as needed (step S8). In this case, an increase quantity of the exposure time or an increase quantity of the gain value is used according to the standard for prescribing performance or the like of the digital camera 100. In addition, the control unit 150 may increase the exposure time and the gain value simultaneously. It should be noted that in step S8 in a case of increasing the exposure time or gain value, it is assumed that the photographer has not decided yet the picture composition of the object. Therefore, for setting each of the exposure time and the gain value to a value suitable for the preview, the control unit 150 makes the gain value larger than the gain value for photography. On top of that, when the luminance value of the image is not sufficient even if the gain value is maximized, the frame rate may be reduced as needed.

It should be noted that the maximum value of the gain for the preview used in step S8 is allowable if it is a gain capable of improving easy recognition of the object even if an image quality of the image during the preview deteriorates due to some degree of an increase in noises of the image during the preview. It is preferable that the maximum value of the gain for the preview is not increased to a magnitude of the gain value causing an increase only in noises without an improvement of easy recognition of the object.

In addition, the frame rate for the preview used in step S8 may be set to any value as long as the frame rate can follow a change of the object during the preview. The frame rate for the preview may be lowered when the luminance value of the image is not sufficient even if the gain value is made larger than the gain value for photography or may be set for reducing noises as much as possible at the time of increasing the gain value. Accordingly, the minimum value of the frame rate for the preview may be lowered to a designed value for photography when the luminance value of the image is not sufficient or the frame rate during the preview may be not reduced from an initial value in a case of placing importance on the follow-up characteristic to a change of the object.

Next, when the control unit 150 determines in step S7 that the entirety of the image, a specific object in the image, or the body of the digital camera 100 stops moving, the exposure time or gain value is made to increase as needed (step S9). In this case, an increase quantity of the exposure time or an increase quantity of the gain value is used according to the standard for prescribing performance or the like of the digital camera 100. In addition, the control unit 150 may increase the exposure time and the gain value simultaneously. It should be noted that in step S8 in a case of increasing the exposure time or gain value, it is assumed that the photographer has not decided the picture composition of the object yet. Accordingly, for setting each of the exposure time and the gain value to a value suitable for photography, the control unit 150 sets the frame rate not to be lower than the minimum value of the frame rate for photography and the gain value not to be larger than the maximum value of the gain for photography.

It should be noted that the minimum value of the frame rate for photography and the maximum value of the gain for photography used in step S9 are, as in the case of the value set by the conventional digital camera, values for reducing the frame rate without increasing the gain value so much and for producing a high quality by a few of noises, and designed values for picking up the image of the object.

Next, when the control unit 150 detects the press-down motion of the photography button in step S4, the control unit 150 determines whether or not each of the frame rate and the gain value is within a range of the setting value for photography (step S10). When the control unit 150 does not detect the press-down motion of the photography button, the process goes back to step S2.

When each of the frame rate and the gain value is within the range of the setting value for photography in step S10, the photography is performed (step S11). When each of the frame rate and the gain value is not within the range of the setting value for photography, the control unit 150 sets each of the frame rate and the gain value within the range of the setting value for photography to perform the photography (step S12). It is preferable that each of the frame rate and the gain value is set to a value in such a manner that an image signal level does not change largely.

It should be noted that there is a case where a photographer desires to photograph an object after the photographer sufficiently confirms an image quality of an image of the object for photography. Therefore, the photography may be performed as follows in step S12, after the control unit 150 again sets each of the frame rate and the gain value within the range of the setting value for photography, the control unit 150 has the photographer to confirm the image quality of the image of the object for photography without performing the photography. Thereafter, when the photography button is again pressed down by the photographer's intent, the photography is performed.

In addition, there may be another method in which the photography button has a mechanism for recognizing a half-pressing state thereof. That is, when the photography button is pressed down half, in step S12 after the control unit 150 again forcibly sets each of the frame rate and the gain value within the range of the setting value for photography, the control unit 150 has the photographer to confirm the image quality of the image of the object for photography. Thereafter, the photography is performed at the time of sufficiently pressing down the photography button.

Further, there may be another method of preparing a button for switching modes for the preview and the photography for the operation unit 140. When a photographer presses down this button, the control unit 150 sets the frame rate and the gain value while switching setting values for the preview and the photography.

It should be noted that when it is determined at step S5 that the luminance value is smaller than a predetermined range, for example, immediately before the photography, the frame rate is lower than the frame rate for the preview. Accordingly, in a case where the frame rate is again not increased to the frame rate for the preview, there is provided a step of determining by the control unit 150 whether or not the frame rate is lowered to the range of the setting value for photography, immediately before step S7. When it is determined that the frame rate is lowered to the range of the setting value, the control unit 150 may perform step S4 without performing step S7.

As described above, according to the digital camera 100, in a case where the entirety of the image, the specific object in the image or the body of the digital camera 100 does not stop moving during the preview at the time of picking up the image of the object in a low brightness, the gain value is set to be larger than the designed value for photography. Therefore, at the time of picking up the image of the object in a low brightness, the object can be confirmed without an excessive reduction of the frame rate during the preview, thus making it possible to quickly respond to and follow the change in the position of the object.

In addition, when a photographer fixes the entirety of the image displayed on the screen, a specific object of the image displayed on the screen, or the body of the digital camera 100, the digital camera 100 automatically sets each of the frame rate and the gain value within a range of the setting value for photography without the photographer's recognition. Thus the photography can be performed with a high image quality by a few of noises. Further, even before the digital camera 100 determines that the position of the object is fixed, for example, an operation for setting each of the frame rate and the gain value to the designed value for photography, that is, for setting them to the image quality for photography, such as an operation for pressing down the photography button is performed. Thereby, the photography can be performed with the image quality for photography. This setting to the image quality for photography may be made also by performing another button or another operation constructed to have the same function.

Further, the conventional digital camera requires a bright optical source or an addition of a new function such as a pixel addition to an image pickup element for easier recognition of the image in a preview mode. However, since the digital camera 100 does not need to add these functions, the conventional image pickup element can be used as it is, thus providing the digital camera with a small-sized, inexpensive construction. In addition, in a case of providing the digital camera 100 with the direction monitoring unit 160, if the gyro sensor, the GPS sensor, the angular velocity sensor, the direction sensor or the like mounted in the conventional digital camera or electronic device is used as the direction monitoring unit 160, the digital camera 100 can be provided with a small-sized, inexpensive construction without an increase of the mounting capacity and the mounting area of the body of the digital camera 100 or an increase of the cost.

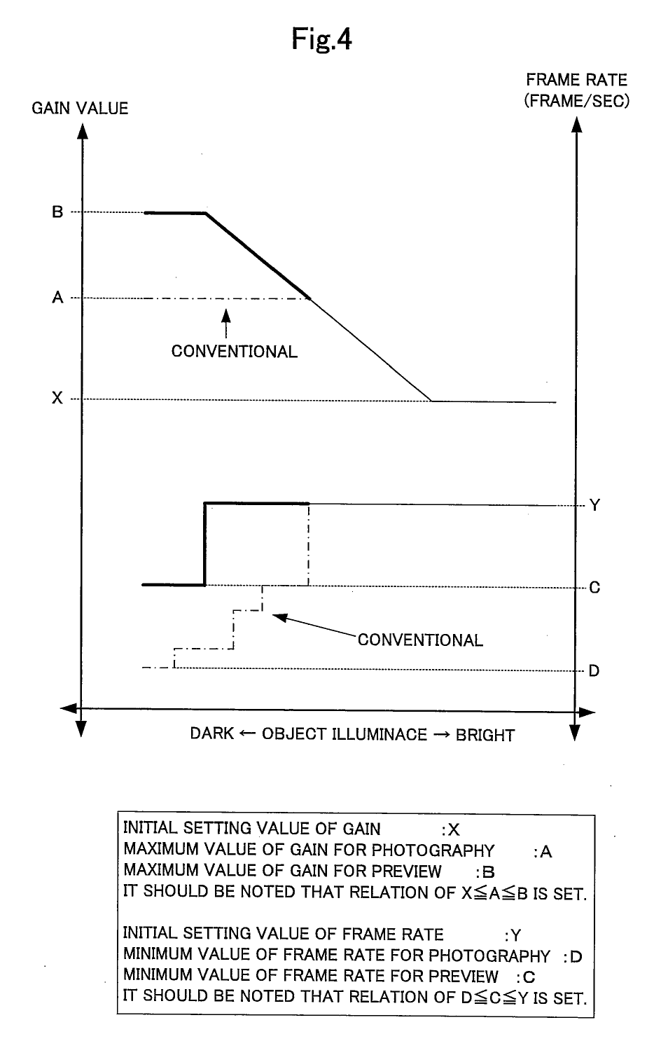

FIG. 4 is a diagram showing one example of a frame rate and a gain value set in the digital camera 100. As shown in FIG. 4, the gain value set in the digital camera 100 increases as the illuminance of an object to be photographed becomes darker and the frame rate set in the digital camera 100 is lowered. As compared to a case of the conventional digital camera, the gain value set in the digital camera 100 is larger and the frame rate set in the digital camera 100 is also larger.

### INDUSTRIAL APPLICABILITY

As described above, the present invention has an advantage of being capable of quickly responding to and following a change in a position of an object with a small-sized, inexpensive construction at the time of picking up an image of the object in a low brightness, and is useful in an electronic device such as a digital camera or a cell phone device.

1. A digital camera comprising:
a body;
a storage unit;
an image pickup unit for picking up an image of an object at regular intervals in a preview mode, and outputting a signal indicative of the image, the image taken by the image pickup unit being stored in the storage unit; and
a control unit or a control unit and a direction monitoring unit provided with a function for changing a gain value of the signal outputted from the image pickup unit and a function for determining whether or not an entirety of the image, a specific object in the image or the body stops moving in the preview mode, wherein
the control unit sets the gain value of the signal to a designed value when the object is larger in illuminance than a predetermined value, or not moving with respect to the body, and increases the gain value of the signal when the object is lower in illuminance than the predetermined value, and moving with respect to the body.

2. A digital camera according to claim 1, wherein:
the control unit includes a function for changing a frame rate, wherein
in a case where the illuminance of the object during the preview is lower than the predetermined value and it is determined that any one or more selected out of the entirety of the image, the specific object in the image or the body does not stop moving, the control unit increases each of the gain value and the frame rate to a value larger than the designed value for the photography.

3. A digital camera according to claim 1, wherein:
in a case where it is determined that any one or more selected out of the entirety of the image, the specific object in the image or the body stops moving and the illuminance of the object is lower than a predetermined value, each of the gain value and the frame rate is made to the designed value for the photography.

4. A digital camera according to any of claim 1, further comprising:
an operation unit including an operation for setting each of the gain value and the frame rate to the designed value for photography, wherein:
even before it is determined that any one or more selected out of the entirety of the image, the specific object in the image or the body stops moving, each of the gain value and the frame rate is instantaneously made to the designed value for photography at the time of performing the operation of setting each of the gain value and the frame rate to the designed value for the photography.

5. An electronic device in which the digital camera according to any of claim 1 is mounted.

6. An image pickup method of a digital camera provided with an image pickup unit for picking up an image of an object and a control unit for controlling an image constructed by a signal outputted from the image pickup unit comprising:
an illuminance determining step in which the control unit determines whether or not the illuminance at the time of picking up the image of the object at the image pickup unit during the preview is lower than a predetermined value;
an object determining step in which the control unit determines whether or not any one or more selected out of an entirety of the image, a specific object in the image or a body stops moving in a case where the control unit determines that the illuminance is lower than the predetermined value at the illuminance determining step; and
a step in which the control unit increases a gain value to a value larger than a designed value for the photography during the preview in a case where the control unit determines that any one or more selected out of the entirety of the image, the specific object in the image or the body does not stop moving at the object determining step.

7. An image pickup method according to claim 6, comprising:
an illuminance determining step in which the control unit determines whether or not the illuminance at the time of picking up the image of the object at the image pickup unit during the preview is lower than a predetermined value;
an object determining step in which the control unit determines whether or not any one or more selected out of an entirety of the image, a specific object in the image or the body stops moving in a case where the control unit determines that the illuminance is lower than the predetermined value at the illuminance determining step; and
a step in which the control unit increases the gain value to the value larger than the designed value for photography during the preview and increase a frame rate to a value larger than that at the photography in a case where the control unit determines that any one or more selected out of the entirety of the image, the specific object in the image or the digital camera body do not stop moving at the object determining step.

8. An image pickup method according to claim 6, comprising:
a step in which the control unit sets each of the gain value and the frame rate to the designed value for photography at the photography.

9. An image pickup method according to claim 6, wherein:
at the object determining step, the control unit compares a position of an entirety of an image incorporated with a position of an entirety of an image previously incorporated to determine whether or not the entirety of the image stops moving.

10. An image pickup method according to claim 6, wherein:
at the object determining step, the control unit compares a position of a specific object in an image incorporated with a position of a specific object of an image previously incorporated to determine whether or not the position of the specific object of the image stops moving.

11. An image pickup method according to claim 6, wherein:
at the object determining step, the control unit determines whether or not the body stops moving based upon the monitoring result of a direction monitoring unit for monitoring whether or not the body stops moving.

12. A program for making a computer perform each step of the image pickup method according to claim 6.
